(19) United States
(12) Patent Application Publication
(10) Pub. No.: US 2020/0096812 A1
(43) Pub. Date: Mar. 26, 2020

(54) DISPLAY DEVICE

(71) Applicant: Japan Display Inc., Tokyo (JP)

(72) Inventors: Shoji HINATA, Tokyo (JP); Shuichi OSAWA, Tokyo (JP); Yoshikatsu IMAZEKI, Tokyo (JP); Yoichi KAMIJO, Tokyo (JP); Yoshihiro WATANABE, Tokyo (JP); Masanobu IKEDA, Tokyo (JP); Toyohiro SAKAI, Tokyo (JP)

(21) Appl. No.: 16/698,281

(22) Filed: Nov. 27, 2019

Related U.S. Application Data
(63) Continuation of application No. PCT/JP2018/019204, filed on May 17, 2018.

(30) Foreign Application Priority Data
May 29, 2017 (JP) 2017-105913

(51) Int. Cl. G02F 1/1335; G02F 1/1362; G02F 1/1339

(52) U.S. Cl. CPC G02F 1/133512; G02F 1/1339; G02F 1/136286; G02F 1/133528

(57) ABSTRACT

According to one embodiment, a display device includes a first substrate including a first basement and a first terminal, a second substrate including a second basement opposing the first terminal and spaced from the first terminal, and a second terminal, and includes a first hole penetrating the second basement, a connection member formed through the first hole, which electrically connects the first terminal and the second terminal to each other, and a light-shielding member which covers the connection member.

### CROSS-REFERENCE TO RELATED APPLICATIONS

This application is a Continuation Application of PCT Application No. PCT/JP2018/019204, filed May 17, 2018 and based upon and claiming the benefit of priority from Japanese Patent Application No. 2017-105913, filed May 29, 2017, the entire contents of all of which are incorporated herein by reference.

### FIELD

Embodiments described herein relate generally to a display device.

### BACKGROUND

Recently, various techniques for narrowing the frames of display devices have been considered. For example, such a technique has been proposed, that a wiring portion comprising an in-hole connection member in a hole which penetrates inner and outer surfaces of a resin-made first substrate and a wiring portion provided on an inner surface of a resin-made second substrate are electrically connected to each other by an inter-substrate connection member.

### SUMMARY

The present application relates generally to a display device.

According to one embodiment, a display device includes a first substrate including a first basement and a first terminal, a second substrate including a second basement opposing the first terminal and spaced from the first terminal, and a second terminal, and includes a first hole penetrating the second basement, a connection member formed through the first hole, which electrically connects the first terminal and the second terminal to each other, and a light-shielding member which covers the connection member.

### BRIEF DESCRIPTION OF THE DRAWINGS

FIG. 1 is a plan view showing a configuration example of a display device of an embodiment.

FIG. 2 is a cross-section of the display panel taken along line A-B shown in FIG. 1.

FIG. 3 is a diagram showing a relationship between a Young's modulus of a light-shielding member and a thermal expansion coefficient, and a stress relating to a connection member.

FIG. 4 is a diagram showing characteristics of a material used for an electro-conductive light-shielding member.

FIG. 5 is a diagram for verifying an appropriate carbon content of the light-shielding member.

FIG. 6 is a cross section showing an example of the display device according to this embodiment.

FIG. 7 is a diagram for verifying whether a metal material used for a connection member and a relay layer forms a stable oxide, a stable nitride, and a stable carbide.

FIG. 8 is a diagram illustrating verification of adhesion between the connection member and an underlying member when using silver fine particles for the connection member.

FIG. 9 is a diagram illustrating verification of adhesion between the connection member and the underlying member when using copper fine particles for the connection member.

FIG. 10 is a diagram illustrating verification of adhesion between the connection member and the underlying member when using gold fine particles for the connection member.

FIG. 11 is a cross section showing an example of the display device according to this embodiment.

FIG. 12 is a cross section showing an example of the display device according to this embodiment.

FIG. 13 is an enlarged view of a surrounding of the hole shown in FIG. 1.

FIG. 14 is a cross section showing an example of the display device according to this embodiment.

FIG. 15 is a diagram showing processing steps for the display device shown in FIG. 6.

FIG. 16 is a diagram showing processing steps for the display device shown in FIG. 6.

FIG. 17 is a diagram showing processing steps for the display device shown in FIG. 14.

FIG. 18 is a diagram showing processing steps for the display device shown in FIG. 14.

FIG. 19 is a diagram showing other processing steps for the display device shown in FIG. 14.

FIG. 20 is a plan view showing locations of the hole and the light-shielding member with relation to each other.

FIG. 21 is a plan view showing other locations of the hole and the light-shielding member with relation to each other.

FIG. 22 is a diagram showing a basic configuration and an equivalent circuit of the display panel shown in FIG. 1.

FIG. 23 is a plan view showing a configuration example of a sensor.

FIG. 24 is a cross section showing a configuration of a display area of the display panel shown in FIG. 1.

FIG. 25 is a cross section showing an example of the display device according to this embodiment.

### DETAILED DESCRIPTION

In general, according to one embodiment, a display device comprises a first substrate comprising a first basement and a first terminal, a second substrate comprising a second basement opposing the first terminal and spaced from the first terminal, and a second terminal, the second substrate comprising a first hole penetrating the second basement, a connection member formed through the first hole, which electrically connects the first terminal and the second terminal to each other, and a light-shielding member which covers the connection member.

The embodiments will be described hereinafter with reference to the accompanying drawings. Note that the disclosure is presented for the sake of exemplification and any modification and variation conceived within the scope and spirit of the invention by a person having ordinary skill in the art are naturally encompassed in the scope of invention of the present application. In addition, in some cases, in order to make the description clearer, the widths, thicknesses, shapes, etc., of the respective parts are schematically illustrated in the drawings as compared to the actual modes. However, the schematic illustration is merely an example, and adds no restrictions to the interpretation of the invention. Moreover, in the specification and drawings, the structural elements which have functions identical or similar to the functions described in connection with preceding drawings are denoted by like reference numbers and an overlapping detailed description thereof is omitted unless otherwise necessary.

The display device of this embodiment can be used in various devices such as smartphones, tablet terminals, mobile phones, notebook computers, and game consoles. The main structure indicated in this embodiment is also applicable for various display devices, for example, liquid crystal display devices, self-luminous display devices such as organic electroluminescent display devices, electronic-paper display devices with an electrophoretic element, display devices adapting micro-electromechanical systems (MEMS), and display devices adapting electrochromism.

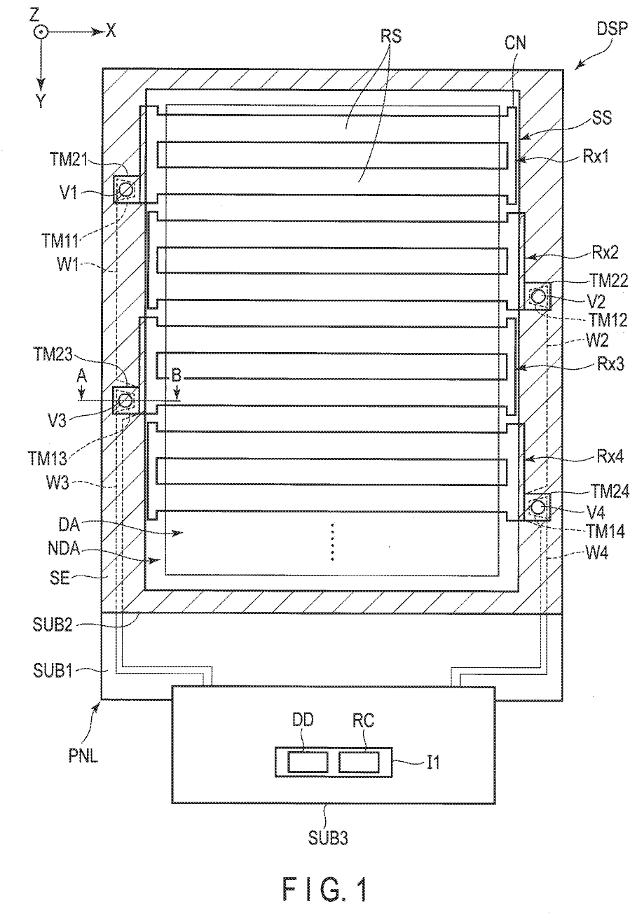

FIG. 1 is a plan view showing a configuration example of a display device DSP of one of the embodiments. Here, as an example of the display device DSP, a liquid crystal display device equipped with a sensor SS will be described.

A first direction X, a second direction Y, and a third direction Z are orthogonal to each other, and but they may cross each other at an angle other than 90 degrees. The first direction X and the second direction Y correspond to directions parallel to the main surface of a substrate which constitutes the display device DSP and the third direction Z corresponds to the thickness direction of the display device DSP. Here, a plane of the display device DSP in an X-Y plane defined by the first direction X and the second direction Y is shown.

The display device DSP includes a display panel PNL, an IC chip I1, a wiring substrate SUB3, and the like. The display panel PNL is a liquid crystal display panel, and includes a first substrate SUB1, a second substrate SUB2, a sealant SE, and a display function layer (liquid crystal layer LC which will be described later). The second substrate SUB2 opposes the first substrate SUB1. The sealant SE corresponds to a part indicated by upward-sloping hatch lines in FIG. 1, and bonds the first substrate and the second substrate SUB2 to each other.

In the following explanation, a direction from the first substrate SUB1 toward the second substrate SUB2 is referred to as upward (or merely above), and a direction from the second substrate SUB2 toward the first substrate SUB1 is referred to as downward (or merely below). A view from the second substrate SUB2 to the first substrate SUB1 is called a plan view.

The display panel PNL includes a display area DA which displays images and a frame-like non-display area NDA around the display area DA. The sealant SE is located in the non-display area NDA.

The wiring substrate SUB3 is mounted on the first substrate SUB1. The wiring substrate SUB3 is, for example, a flexible substrate. Note that it suffices if a flexible substrate applicable in this embodiment includes a flexible portion formed from a bendable material in at least one part thereof. For example, the wiring substrate SUB3 of this embodiment may be a flexible substrate entirely formed from a flexible portion, or may be a rigid flexible substrate including a rigid portion formed of a hard material such as glass epoxy and a flexible portion formed of a bendable material such as polyimide.

The IC chip I1 is mounted on the wiring substrate SUB3. Note that the embodiment is not limited to the example illustrated, but the IC chip I1 may be mounted on a portion of the first substrate SUB1, which extends out from the second substrate SUB2, or may be mounted on an external circuit board connected to the wiring substrate SUB3. The IC chip I1 contains, for example, a built-in display driver DD which outputs a signal necessary to display images. The display driver DD described in this specification includes at least a part of a signal line drive circuit SD, a scanning line drive circuit GD, and a common electrode drive circuit CD, which will be described later. In the example illustrated, the IC chip I1 contains a built-in detection circuit RC which functions as a touch panel controller or the like. The detection circuit RC may be incorporated in an IC chip different from the IC chip I1.

The display panel PNL may be any one of the transmissive type provided with a transmissive display function of displaying images by selectively transmitting light from below the first substrate SUB1, a reflective type provided with a reflective display function of displaying images by selectively reflecting light from above the second substrate SUB2, and a transreflective type provided with both the transmissive display function and the reflective display function.

The sensor SS senses an object to be detected being in contact with or approaching the display device DSP. The sensor SE comprises a plurality of detection electrodes Rx (Rx1, Rx2, . . . ). The detection electrodes Rx are provided on the second substrate SUB2. The detection electrodes Rx each extend in the first direction X and are arranged along the second direction Y at intervals respectively therebetween.

FIG. 1 illustrates the detection electrodes Rx1 to Rx4 as the detection electrodes Rx and here a configuration example thereof will now be described while focusing on the detection electrode Rx1. That is, the detection electrode Rx1 comprises a detector RS and a connector CN.

The detector RS is located in the display area DA and extends along the first direction X. In the detection electrode Rx1, the detector RS is mainly used for sensing. Note that one detection electrode Rx1 comprises two detectors RS but may comprise three or more detectors RS or just one detector RS. The connector CN is located in the non-display area NDA to connect the detectors RS to each other.

Here, how the first substrate SUB1 and the second substrate SUB2 are connected each other will be described. Note that in FIG. 1, one end side of the non-display area NDA corresponds to a left-hand side with respect to the display area DA, and the other end side of the non-display area NDA corresponds to a right-hand side of the display area DA.

The first substrate SUB1 comprises a first terminal TM1 and a wiring line W1, electrically connected to the wiring substrate SUB3. The first terminal TM1 and the wiring line W1 are located on the one end side of the non-display area NDA and overlap the sealant SE in plan view. The wiring line W1 is connected to the first terminal TM11 and extends along the second direction Y, and is electrically connected to the detection circuit RC of the IC chip I1 via the wiring substrate SUB3.

On the other hand, the second substrate SUB2 comprises a second terminal TM21 electrically connected to the detection electrode Rx1. The second terminal TM21 is located in one end side of the non-display area NDA, and overlaps the first terminal TM11 in plan view.

Note that unless it is necessary to identify individual terminals, the first terminals TM11, TM12, . . . , will referred to as the first terminals TM1, and the second terminals TM21, TM22, . . . , will be referred to as the second terminals TM2.

A connection hole V1 is formed at a position where the second terminal TM21 and the first terminal TM11 oppose each other. The connection hole V1 penetrates the second substrate

SUB2 including the second terminal TM21 and the sealant SE. The connection hole V1 may penetrate the first terminal TM11 as well. As will be described later, the hole V1 is provided with a conductive connection member C. Thus, the first terminal TM11 and the second terminal TM21 are electrically connected to each other. That is, the detection electrodes Rx1 provided on the second substrate SUB2 are electrically connected to the detection circuit RC via the wiring substrate SUB3 which is connected to the first substrate SUB1. The detector RC reads sensor signals output from the detection electrodes Rx so as to detect contacting, approaching of an object to be detected or position coordinates of the object, etc. In the example illustrated, the first terminals TM11, TM13, . . . , the second terminals TM21, TM23, . . . , the wiring lines W1, W3, . . . , the connection holes V1, V3, . . . , connected respectively to odd-numbered detection electrodes Rx1, Rx3, . . . , are all located on one end side of the non-display area NDA. Moreover, the first terminals TM12, TM14, . . . , the second terminals TM22, TM24, . . . , the wiring lines W2, W4, . . . , the connection holes V2, V4, . . . , connected respectively to even-numbered detection electrodes Rx2, Rx4, . . . , are all located on the other end side of the non-display area NDA. According to such a layout, the width on one end side of the non-display area NDA and the width on the other end side can be equalized, and such a layout is suitable for narrowing the frame.

As shown, the wiring line W1 detours an inner side (side close to the display area DA) of the first terminal TM13, and is disposed along an inner side of the wiring line W3 between the first terminal TM13 and the wiring substrate SUB3. Similarly, the wiring line W2 detours around on an inner side of the first terminal TM14, and is disposed on an inner side of the wiring line W4 between the first terminal TM14 and the wiring substrate SUB3.

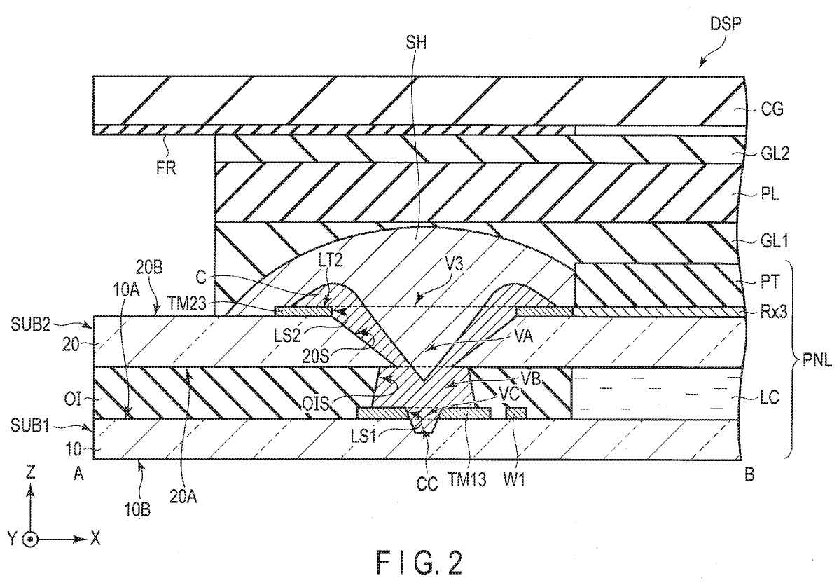

FIG. 2 is a cross section of the display panel DSP taken along line A-B shown in FIG. 1. The display device DSP comprises a display panel PNL, a polarizer PL, a cover member CG a connection member C, a light-shielding member SH, etc.

The display panel PNL includes the first substrate SUB1, the second substrate SUB2, an organic insulating film OI, a liquid crystal layer LC and the like. The first substrate SUB1 and the second substrate SUB2 oppose each other along the third direction Z.

The first substrate SUB1 includes a first basement 10, the first terminal TM13 and the wiring line W1. The first basement 10 comprises a main surface 10A opposing the second substrate SUB2 and another main surface 10B on an opposite side to the surface 10A. In the example illustrated, the first terminal TM13 and the wiring line W1 are located on a main surface 10A side. The wiring line W1 is disposed between the first terminal TM13 and the liquid crystal layer LC. Although not illustrated, various insulating films and various conducting films may be provided between the first terminal TM13 and further the wiring line W1 and the first basement 10, and on the first terminal TM13 and the wiring line W1. Moreover, the first terminal TM13 and the wiring line W1 may be formed in separate layers from each other via insulating films or the like.

The second substrate SUB2 includes a second basement 20, the second terminal TM23, the detection electrode Rx3, and a protective member PT. The second basement 20 comprises a main surface 20A opposing the first substrate SUB1 and another main surface 20B on an opposite side to the surface 20A. The main surface 20A opposes the first terminal TM13, and is spaced from the first terminal TM13 along the third direction Z. The first basement 10 and the second basement 20 described above are formed from, for example, non-alkali glass. The first basement 10 and the second basement 20 may be formed of, for example, a resin. In the example illustrated, the second terminal TM23 and the detection electrode Rx3 are located on a main surface 20B side. The second terminal TM23 and the detection electrode Rx3 are electrically connected to each other. The protective member PT is disposed on the detection electrode Rx3. Note that the protective member PT may be provided on the second terminal TM23 as well. Further, although not illustrated, various insulating layers and conductive layers may be provided between the second terminal TM23 and further the detection electrode Rx3, and the second basement 20.

The organic insulating layer OI is located between the first basement 10 and the second basement 20. Here, the insulating layer IL includes, for example, at least one of a light-shielding layer, a color filter, an overcoat layer, an alignment film and a sealant, which will be described later. The liquid crystal layer LC is located in an area surrounded by the first substrate SUB1, the second substrate SUB2 and the organic insulating film OI.

Here, the connection structure between the first terminal TM11 and the second terminal TM21 will be explained in detail.

In the second substrate SUB2, the second basement 20 includes a hole (first hole) VA penetrating between the main surfaces 20A and 20B. In the example illustrated, the hole VA penetrates the second terminal TM23 as well.

The organic insulating film OI comprises a hole (third hole) VB communicating to the hole VA between the first substrate SUB1 and the second substrate SUB2.

On the other hand, in the first substrate SUB1, the first terminal TM13 comprises a hole VC communicating to the hole VB. Moreover, the first basement 10 comprises a concavity CC opposing the hole portion VC along the third direction Z. The concavity CC is formed from the main surface 10A towards the main surface 10B and but does not penetrate to reach the surface 10B in the example illustrated. For example, a depth of the concavity CC along the third direction Z is about one fifth to about a half of a thickness of the first basement 10 along the third direction Z. Note that the first basement 10 may include a hole penetrating between the main surfaces 10A and 10B in place of the concavity CC. The holes VA, VB, VC and the concavity CC are located along on the same straight line along the third direction Z, and form the connection hole V3.

In the example illustrated, the hole VB is expanded along the first direction X as compared to the hole VA or hole VC in the main surface 20A, but the hole VB is expanded not only along the first direction X but in all the directions in the X-Y plane.

The connection member C is provided via the holes VA and VB so as to electrically connects the first terminal TM13 and the second terminal TM23 to each other. More specifically, the connection member C is provided on an inner surface of each of the holes VA, VB and VC and the concavity CC. In the example illustrated, the connection member C is provided continuously in the holes VA, VB and VC and the concavity CC without being broken. The connection member C contains a metal material, and more specifically, should preferably be of a type which contains fine particles of the metal material, which have particle diameters on the order of several nanometers to tens of nanometers, dispersed in a solvent. Examples of the metal used for the connection member C are copper, silver and gold.

In the example illustrated, the connection member C is in contact with each of the an upper surface LT2 of the second terminal TM23, an inner surface LS2 of the second terminal TM23, and an inner surface 20S of the second basement 20 in the second substrate SUB2. The inner surfaces LS2 and 20S form an inner surface of the hole VA. The connection member C is in contact with an inner surface OIS of the organic insulating film OI between the first substrate SUB1 and the second substrate SUB2. The inner surface OIS forms an inner surface of the hole VB. Moreover, the connection member C is also in contact with each of an inner surface LS1 of the first terminal TM13 and the concavity CC in the first substrate SUB1. The inner surface LS1 forms the inner surface of the hole VC.

In the example illustrated, the connection member C is provided on the inner surface of each of the holes VA, VB and VC and the concavity CC, but it may be provided to fill and bury the holes VA, VB and VC and the concavity CC. In this case as well, the connection member C is formed continuously without being broken between the first terminal TM13 and the second terminal TM23.

The light-shielding member SH covers the connection member C and the second terminal TM23. Moreover, the light-shielding member SH has light-shielding properties. In this embodiment, the material which has light-shielding properties is defined as a material having an optical density (OD) value of 1 or higher. Moreover, the light-shielding member SH is provided into a hollow section of the connection hole V3 to fill. With the light-shielding member SH provided, the difference in level along the third direction Z, which is caused by the hollow section formed in the connection hole V3 can be reduced. Moreover, the connection member C can be protected. Further, when the connection member C contains metal, as the light-shielding member SH covers the connection member C, the light-shielding member SH shields reflection light in the connection member C. Thus, glare resulting from the connection member C can be suppressed.

The light-shielding member SH may be, for example, conductive. When the light-shielding member SH is conductive, the light-shielding member SH can electrically connect the first terminal TM13 and the second terminal TM23 to each other even if the connection member C breaks off, thereby making it possible to improve the reliability.

The light-shielding member SH may be, for example, non-conductive. When the light-shielding member SH is non-conductive, for example, the type of the filler contained in the light-shielding member SH, or the type of the pigment for coloring the light-shielding member SH, are not limited to conductive materials. Thus, the range of the types of fillers and pigments can be expanded. Moreover, as will be discussed later, when the light-shielding member SH is non-conductive, the light-shielding member SH may be formed continuously to overlaps a plurality of adjacent connection holes.

In this embodiment, the non-conductive material is defined as a material having a resistance of 10⁸Ω or higher. Moreover, in this embodiment, the conductive material is defined as a material having a resistance lower than of 10⁸Ω.

In this embodiment, the light-shielding member SH contains carbon. In this case, the light-shielding member SH may be conductive or non-conductive. When the light-shielding member SH contains carbon, light-shielding properties can be imparted to the light-shielding member SH. Detailed characteristics of the material used for the light-shielding member SH will be discussed later. Note that when the light-shielding member SH is conductive, in this embodiment, the light-shielding member SH contains at least one material of, for example, graphene, a carbon nanotube, a carbon nanobud, carbon black and glassy carbon. When the light-shielding member SH is non-conductive, the light-shielding member SH contains any one of carbon, titanium oxide (for example, TiO₂), iron oxide (for example, triiron tetroxide), and a complex oxide of copper and chromium. Moreover, the light-shielding member may further contain pigments.

The polarizer PL is attached above the display panel PNL via an adhesive GL1. The polarizer PL opposes the second substrate SUB2. The cover member CG is adhered above the polarizer PL via an adhesive GL2. The cover member CG is formed of, for example, glass. Moreover, the cover member CG includes, for example, a printed frame portion FR. The frame portion FR is formed, for example, continuously so as to surround the display area. Moreover, the frame portion FR overlaps the connection hole V3 along the third direction Z. Furthermore, the light-shielding member SH may be disposed on a lower surface of the cover member CG in the position overlaps the connection member C.

According to this embodiment, the light-shielding member SH covers the connection member C containing, for example, a metal material. With this structure, it is possible by the light-shielding member SH to suppress reflection of the connection member C from becoming visible through the polarizer PL. Especially, it is possible to suppress reflection of the connection member C from becoming visible when the display device DSP is seen diagonally with respect to a normal direction. Thus, the visibility defect of the display device DSP can be suppressed.

The light-shielding member SH is provided into the hollow section of the connection hole V3 to fill, so as to cover the connection member C also inside the connection hole V3. Thus, the oxidization of the connection member C can be suppressed. Moreover, the adhesion of the connection member C to various insulating films and various conducting films, which form the connection hole V3, can be improved. Therefore, the reliability of the electric connection of the connection member C can be improved.

Moreover, according to this embodiment, as shown in FIGS. 1 and 2, the second terminal TM2 is electrically connected to the wiring substrate SUB3 via the connection member C, the first terminal TM1 and the like. Therefore, the control circuits for writing signals to the detection electrodes Rx or reading signals output from the detection electrodes Rx can be connected to the detection electrodes Rx via the wiring substrate SUB3. That is, it is no longer necessary to mount another wiring substrate on the second substrate SUB2 to connect the detection electrodes Rx and the control circuits to each other.

Moreover, according to this embodiment, as compared to the case where another wiring substrate is mounted on the second substrate SUB2 in addition to the wiring substrate SUB3 mounted on the first substrate SUB1, terminals for mounting such a wiring substrate or wiring lines for connecting the second terminal TM2 to the wiring substrate are no longer necessary. Therefore, in the X-Y plane defined by the first direction X and the second direction Y, the board size of the second substrate SUB2 can be reduced, and also the frame width of the peripheral portion of the display device DSP can be reduced. In addition, the cost for the other wiring substrate, which is no longer necessary, can be reduced. In this way, a narrow frame and low cost can be achieved.

Next, the characteristics of the material used for the light-shielding member in this embodiment will be described.

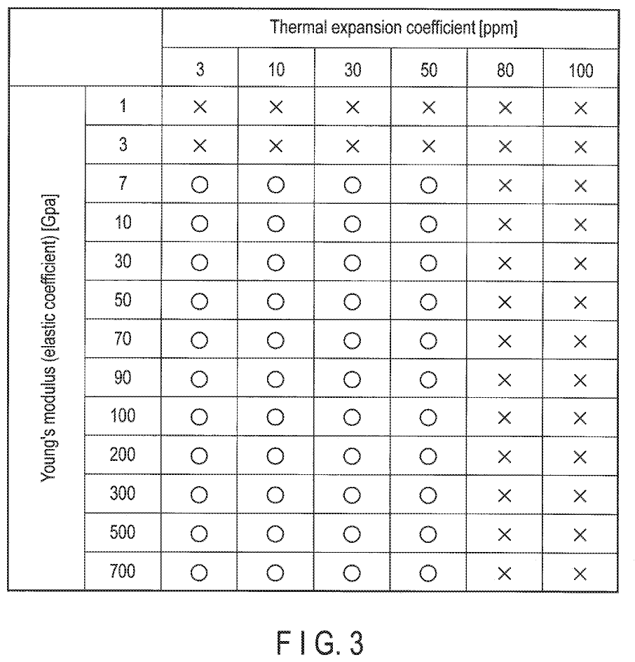

FIG. 3 is a diagram showing a relationship between a Young's modulus and a thermal expansion coefficient of the light-shielding member and a stress relating to the connection member. In this embodiment, the connection member has a Young's modulus of 10 to 90 GPa, and a coefficient of linear expansion of 10 ppm or less. In order to maintain the function of protecting the connection member if exposed to a temperature change in the manufacturing process, or a temperature change in the outdoor environment, the light-shielding member needs to have a predetermined level or higher of the Young's modulus and a predetermined level or lower of the linear expansion coefficient. In other words, in terms of protection of the connection member, the Young's modulus of the material used for the light-shielding member should desirably be high as possible, and the thermal expansion coefficient should desirably be low as possible. Moreover, when the light-shielding member is conductive, the light-shielding member needs to have a predetermined level or lower of resistivity. As described above, a material that satisfies the above-described conditions in Young's modulus, thermal expansion coefficient and resistivity is applied as the material used for the light-shielding member.

FIG. 3 shows results of testing of the light-shielding member in terms of Young's modulus and thermal expansion coefficient when the stress produced in the connection member is reduced to 60 MPa or less by changing the Young's modulus and the thermal expansion coefficient of the light-shielding member and the temperature. Here, the Young's modulus of the light-shielding member is changed in a range of 1 to 700 GPa, the thermal expansion coefficient of the light-shielding member is changed in a range of 3 to 100 ppm, and the temperature is changed from −40° C. to 85° C.

Circles (∘) in the table indicate the cases where the stress produced in the connection member is 60 MPa or less, and crosses (x) indicate the cases where the stress produced in the connection member is greater than 60 MPa. That is, when the Young's modulus of the light-shielding member is 7 to 700 GPa and simultaneously when the thermal expansion coefficient of the light-shielding member is 3 to 50 ppm, the stress produced in the connection member is 60 MPa or less. Based on these results, in this embodiment, the conditions of the light-shielding member are set that the Young's modulus should be 7 GPa or greater and the thermal expansion coefficient should be 50 ppm or less.

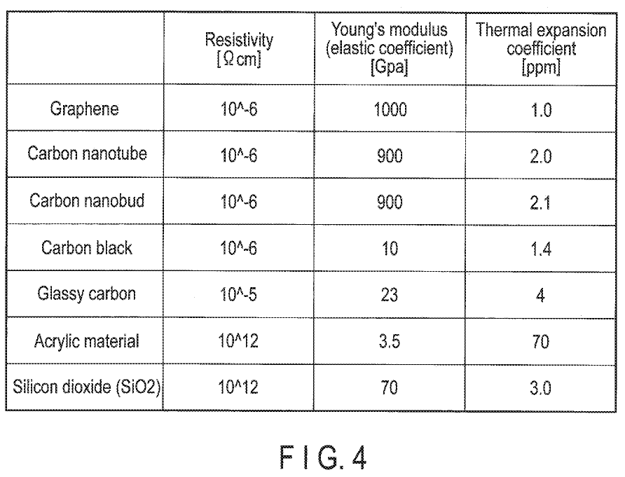

FIG. 4 is a diagram showing the characteristics of the material used for the light-shielding member which has conductivity. Here, as comparative examples, the characteristics of an acrylic material and silicon dioxide (SiO₂), which are insulating materials, are also shown.

Based on the conditions of the Young's modulus, thermal expansion coefficient and resistivity shown in FIG. 3, graphene, a carbon nanotube, a carbon nanobud, carbon black, and glassy carbon can be listed as examples of the carbon material. As shown in FIG. 4, as compared to acrylic material and SiO₂, graphene, a carbon nanotube, a carbon nanobud, carbon black, and glassy carbon exhibit low resistivity, high Young's modulus, and low thermal expansion coefficient. As to the light-shielding member containing the carbon material of this embodiment, the content of the carbon material is set such as to achieve, for example a Young's modulus of 7 GPa or higher and a thermal expansion coefficient of 50 ppm or less.

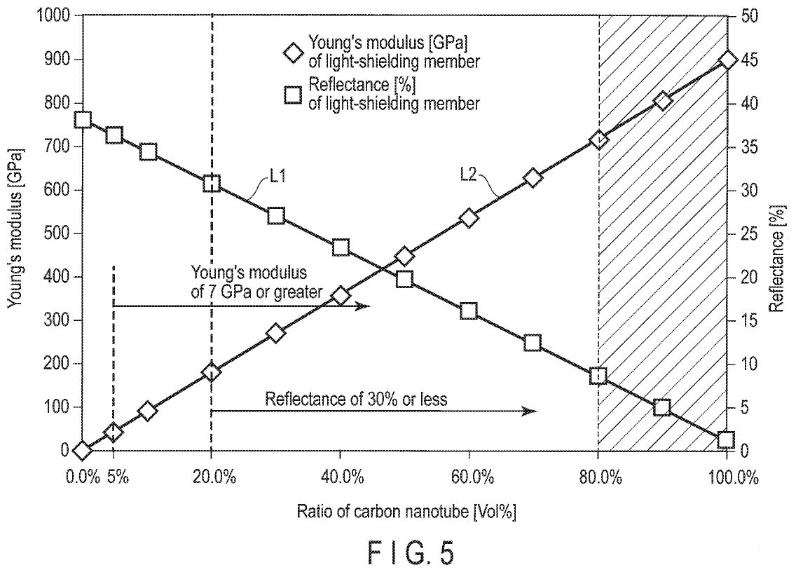

FIG. 5 is a diagram for verifying appropriate carbon content of the light-shielding member. Here, the verification is carried out using the light-shielding member prepared from an epoxy material containing carbon nanotubes.

The horizontal axis indicates the carbon nanotube ratio, which is the content of the carbon nanotubes with respect to the light-shielding member. The carbon nanotube ratio is indicated in a range of 0 to 100%. The left-hand side vertical axis indicates the Young's modulus of the light-shielding member. The Young's modulus is indicated in a range of 0 to 1000 GPa.

The right-hand side vertical axis indicates the reflectance of the light-shielding member. The reflectance is indicated in a range of 0 to 50%. In the graph, a line L1 indicates the reflectance of the light-shielding member and a line L2 indicates the Young's modulus of the light-shielding member.

The verification was carried out to find such a carbon nanotube ratio for the light-shielding member that can achieve a Young's modulus of 7 GPa or higher and a reflectance of 30% or less, and simultaneously that can secure the adhesion of the light-shielding member. It was found that when the carbon nanotube ratio is about 5% or higher, the Young's modulus is 7 GPa or higher. Moreover, when the carbon nanotube ratio is about 20% or higher, the reflectance is 30% or less. Based on the conditions of the Young's modulus and the reflectance, it is desirable that the carbon nanotube ratio should be 20% or higher. However, when the carbon nanotube ratio is higher than 80%, the ratio of the epoxy material in the light-shielding member is small; therefore it is possible to secure the adhesion of the light-shielding member. Thus, it is desirable that the carbon nanotube ratio be 20 to 80%.

Next, an example of the display device DSP of this embodiment will be described.

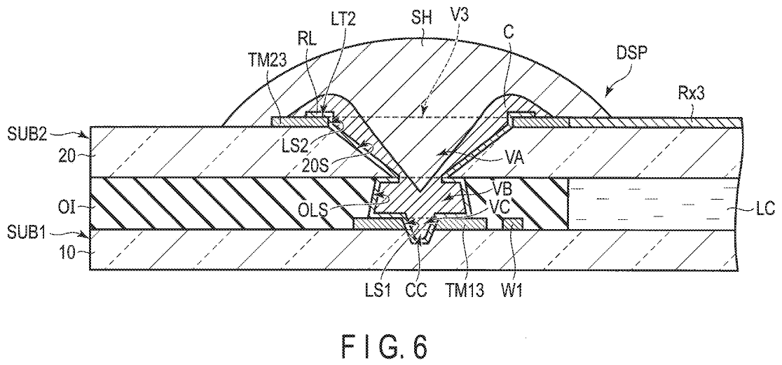

FIG. 6 is a cross section of the example of the display device DSP according to this embodiment. Note that the layers above the detection electrode Rx3 are omitted from the illustration here. The structure shown in FIG. 6 is different from that of FIG. 2 in that the display device DSP comprises a relay layer RL.

In the example illustrated, the relay layer RL is in contact with each of an upper surface LT2, an inner surface LS2 and an inner surface 20S in the second substrate SUB2. The relay layer RL is in contact with an inner surface OIS between the first substrate SUB1 and the second substrate SUB2. Further, the relay layer RL is in contact with each of an inner surface LS1 and a concavity CC in the first substrate SUB1. That is, the relay layer RL is located between the connection member C and the second electrode TM23 and between the connection member C and the second basement 20, in the hole VA. The relay layer RL is located between the connection member C and the organic insulating film OI in the hole VB. The relay layer RL is located between the connection member C and the first electrode TM13 in the hole VC. The relay layer RL is located between the connection member C and the first basement 10 in the concavity CC.

As shown in FIG. 2, when the relay layer RL is not provided, the connection member C is brought into contact with the first basement 10, the second basement 20 and the like, which are inorganic films, with the organic insulating film OI and the like, which are organic films, and with the first electrode TM13, the second electrode TM23 and the like, which is are metallic films. That is, the connection member C is brought into contact with inorganic films, organic films, and metallic films all at the same time. Here, between the metal material used for the connection member C and nitrogen, oxygen and carbon contained in the inorganic films and the organic films, there is no such a great difference in electronegativity that the adhesion of the connection member C can be secured. Further, the metal material used for the connection member C cannot easily form a stable nitride, a stable oxide, or a stable carbide. As a result, there is a possibility that the connection member C may be detached from the inorganic films and the organic films.

Moreover, as shown in FIG. 2, when the relay layer RL is not provided, the connection member C has a largest contact area with respect to the second basement 20 in the connection hole V3. However, since there is a great difference in Young's modulus between the metal material (for example, Cu, Ag, Au) used for the connection member C and the material (for example, glass) used for the second basement 20, local thermal stress is applied to the connection member C due to a change in temperature, creating a possibility that the connection member C is detached from the second basement 20.

Under these circumstances, in this embodiment, the relay layer RL is formed such that the difference in electronegativity between the relay layer RL and the inorganic films and the organic films becomes greater than the difference in electronegativity between the connection member C and the inorganic films and the organic films. In this embodiment, the relay layer RL contains a transition metal. As will be discussed later, as to the transition metals, it is desirable that the relay layer RL should contain, especially, such a transition metal that can form a stable oxide, a stable nitride, and a stable carbide. It is desirable that the transition metal contained in the relay layer RL should be at least one of, for example, titanium (Ti), zirconium (Zr), hafnium (Hf) and tantalum (Ta). Note that the difference in electronegativity between Ti, Zr, Hf and Ta and nitrogen, oxygen and carbon is greater than the difference in electronegativity between the metal material, and nitrogen, oxygen and carbon used for the connection member C. That is, as compared to the connection member C, with the relay layer RL, high adhesion the organic films and inorganic films can be obtained.

Therefore, even if the temperature change in the manufacturing process and the temperature change in the outdoor environment repeatedly take place, the adhesion between the connection member C and the inorganic films and the organic films can be maintained via the relay layer RL. It has been confirmed that that with the formation of the relay layer RL, the connection member C is not detached in thermal cycle tests carried out between −40° C. and 80° C. Moreover, the electric connection between the connection member C and the relay layer RL is also excellent. Furthermore, with the relay layer RL, the adhesion to the inorganic films and the adhesion to the organic films can be secured at the same time, and therefore, it can be used for such a structure as shown in FIG. 6 that the relay layer RL is in contact with the inorganic films and the organic films all at the same time.

In the example illustrated, the relay layer RL is disposed on the entire inner surface of the connection hole V3, but it may be arranged on a part of the inner surface of the connection hole V3. In this case, it is desirable that the relay layer RL be disposed at least between the connection member C and the second basement 20.

The adhesion between the connection member and the inorganic films and the organic films can be secured by the relay layer RL, whereas the adhesion between the connection member and the light-shielding member can be secured by the adhesion of the resin material used for the light-shielding member.

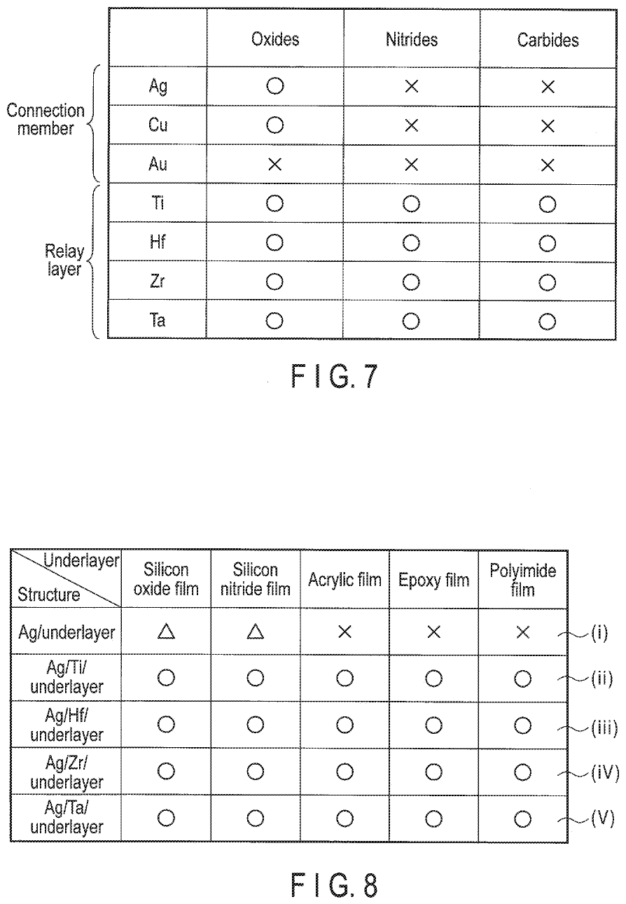

FIG. 7 is a diagram for verifying whether or not the metal material used for the connection member and the relay layer forms a stable oxide, stable nitride, and stable carbide. Circles (∘) in the table indicate the cases where the metal material can form a stable compound, and crosses (×) indicate the cases where the metal material cannot form a stable compound.

In the example illustrated, Ag, Cu and Au are usable metal materials for the connection member. Here, Ag forms a stable oxide, but cannot form a stable nitride or stable carbide. Cu forms a stable oxide, but cannot form a stable nitride or stable carbide. Au cannot form any of a stable oxide, stable nitride and stable carbide. That is, none of Ag, Cu and Au can form a stable oxide, stable nitride and stable carbide all at the same time. Therefore, when the connection member is in contact with the organic films and the inorganic films all at the same time, it is difficult to secure the adhesion of the connection member.

In the example illustrated, Ti, Hf, Zr and Ta are usable metal materials for the relay layer. Ti, Hf, Zr, and Ta each can form a stable oxide, stable nitride, and stable carbide at the same time. Therefore, even if the relay layer is in contact with the organic films and the inorganic films all at the same time, the adhesion of the relay layer can be secured.

FIGS. 8 to 10 each show verifications of the adhesion between the connection member and the inorganic films and the organic films, resulting due to the presence of the relay layer.

Here, the adhesion between the connection member and the inorganic films and the organic films was verified using the crosscut method specified by Japanese Industrial Standard (JIS K 5600). Note that in FIGS. 8 to 10, the inorganic films and the organic films are referred to generically as an underlayer.

FIG. 8 is a diagram of verification of the adhesion between the connection member and the underlayer when silver particles are used for the connection member. Here, crosses (×) indicate the cases where the connection member is substantially entirely detached from the underlayer, triangles (Δ) indicate the cases where the connection member is partially detached from the underlayer, and circles (∘) indicate the cases where the connection member is not detached from the underlayer. In the example illustrated, the silicon oxide film and the silicon nitride film are inorganic films, whereas the acrylic film, epoxy film and polyimide film are organic films. Moreover, usable metal materials for the relay layer are Ti, Hf, Zr and Ta.

The first row (i) of the table indicates the case where the relay layer is not provided between the connection member and the underlayer, whereas the second row (ii), the third row (iii), the fourth row (iv), and the fifth row (v) each indicate the case where the relay layer containing Ti, Hf, Zr or Ta, respectively, is provided between the connection member and the underlayer.

As shown in the first row (i), when the relay layer is not formed between the connection member and the underlayer, the connection member is partially detached from the silicon oxide film and the silicon nitride film, and is entirely detached from the acrylic film, the epoxy film and the polyimide film. On the other hand, as shown in the second to fifth rows, when the relay layer is formed between the connection member and the underlayer, the connection member is not detached from the silicon oxide film, the silicon nitride film, the acrylic film, the epoxy film, and the polyimide film.

Thus, it was found that when the connection member is formed using silver, the adhesion between the connection member and the underlayer can be secured by forming the relay layer.

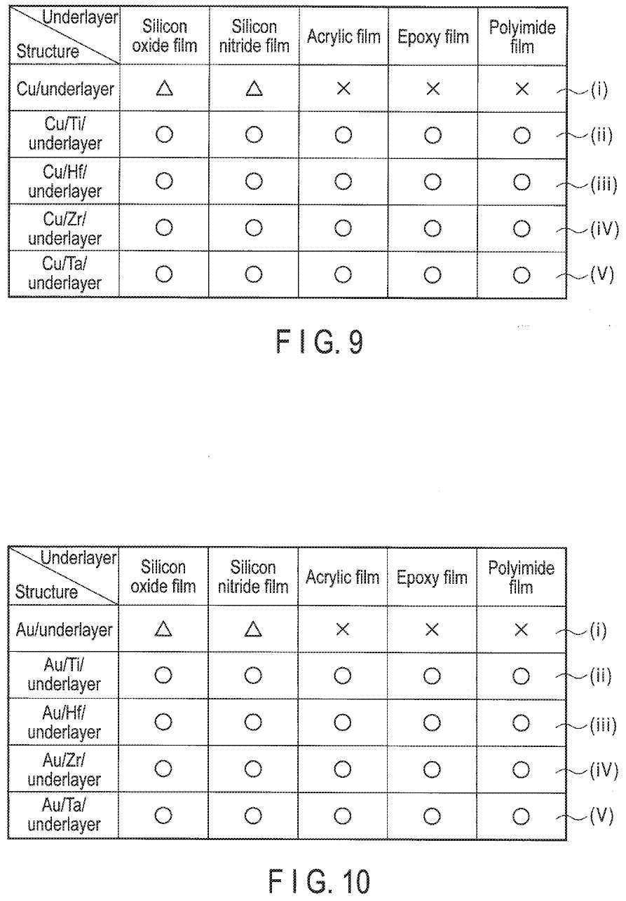

FIG. 9 is a diagram of verification of the adhesion between the connection member and the underlayer when copper particles are used as the connection member.

As in the case shown in FIG. 8, when the relay layer is not formed between the connection member and the underlayer, the connection member is partially detached from the inorganic films, and entirely separated from the organic films. On the other hand, when the relay layer is formed between the connection member and the underlayer, the connection member is not detached from the inorganic films and the organic films.

Thus, it was found that when the connection member is formed using copper, the adhesion between the connection member and the underlayer can be secured by forming the relay layer.

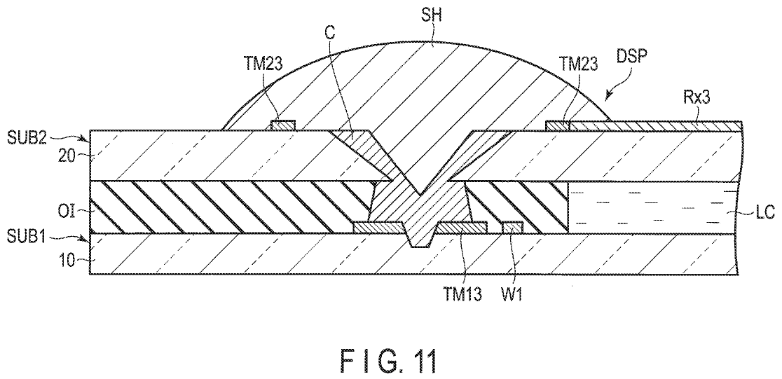

FIG. 10 is a diagram of verification of the adhesion between the connection member and the underlayer when gold particles are used as the connection member.

As in the case shown in FIG. 8, when the relay layer is not formed between the connection member and the underlayer, the connection member is partially detached from the inorganic films, and entirely separated from the organic films. On the other hand, when the relay layer is formed between the connection member and the underlayer, the connection member is not detached from the inorganic films and the organic films.

Thus, it was found that when the connection member is formed using gold, the adhesion between the connection member and the underlayer can be secured by forming the relay layer.

In the examples shown in FIGS. 6 to 10 as well, advantageous effects similar to those of the above-described embodiment can be obtained.

FIG. 11 is a cross section showing an example of the display device DSP according to this embodiment. The structure shown in FIG. 11 is different from that of FIG. 2 in that the connection member C is spaced from the second electrode TM23.

In the example shown in FIG. 11, the light-shielding member SH is conductive. Moreover, the light-shielding member SH is in contact with the connection member C and the second terminal TM23. With this structure, even if the connection member C is spaced from the second electrode TM23, the connection member C and second electrode TM23 can be electrically connected to each other by the light-shielding member SH. Note that when the light-shielding member SH is non-conductive, the connection member C is in contact with the second electrode TM23 as shown in FIG. 2.

In the example shown in FIG. 11 as well, advantageous effects similar to those of the above-described embodiment can be obtained.

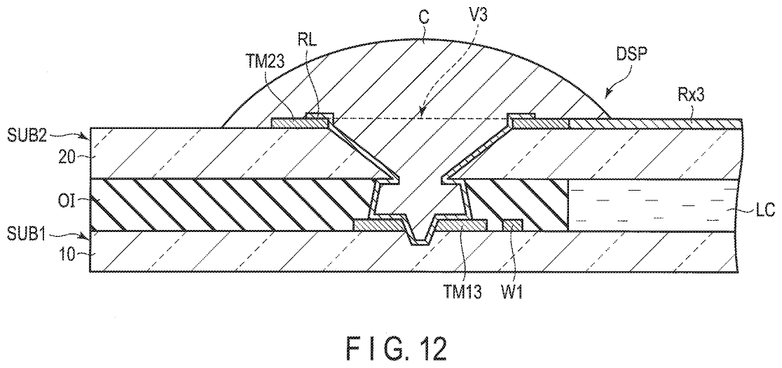

FIG. 12 is a cross section of another example of the display device DSP according to this embodiment. The structure shown I FIG. 12 is different from that of FIG. 2 in that the connection hole V3 is filled with the connection member C in place of the light-shielding member SH, and also the relay layer RL is disposed on the inner surface in the connection hole V3.

The connection member C covers the second electrode EL23 and the relay layer RL. In the example shown in FIG. 12, the connection member C has light-shielding properties. That is, the connection member C has a function equivalent to that of the light-shielding member SH shown in FIG. 2 and also a function equivalent to that of the connection member C shown in FIG. 2. The connection member C contains carbon in addition to the metal materials described above. When the connection member C contains carbon, the light-shielding properties can be imparted to the connection member C. Moreover, the connection member C is formed using at least one of, for example, grapheme, carbon nanotube, carbon nanobud, carbon black and glassy carbon, which have conductivity as carbon. The connection member C with such contents has a

Young's modulus of 7 GPa or higher and a thermal expansion coefficient of 50 ppm or less as in the case of the light-shielding member SH. Moreover, the relay layer RL is disposed between the connection member C and the second basement 20, the organic insulating film OI, the first basement 10, the first electrode TM13 and the second electrode TM23. With this structure, it was confirmed that the connection member C is not detached in the thermal cycling test in a range from −40° C. to 80° C. Moreover, the electric connection between the connection member C and the relay layer RL was also excellent.

In the example shown in FIG. 12 as well, advantageous effects similar to those of the above-described embodiment can be obtained.

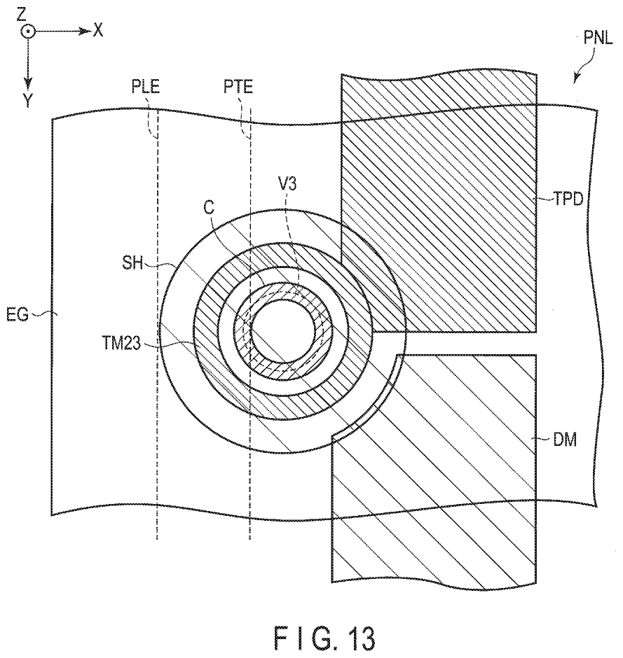

FIG. 13 is an enlarged view of the surrounding of the hole V3 shown in FIG. 1.

The display panel PNL further comprises an inspection pad TPD and a dummy pad DM. The inspection pad TPD is electrically connected to the second electrode TM23. The dummy pad DM is arranged by the inspection pad TPD along the second direction Y. The second terminal TM21 is formed into a ring shape. The connection hole V3 and the connection member C are formed in an inner side of the second terminal TM23. The light-shielding member SH overlaps the connection member C and the second terminal TM23.

An end portion EG of the display panel PNL extends along the second direction Y. Moreover, an end portion PTE of the protective member and an end portion PLE of the polarizer extend along the second direction Y. The end portion PLE is located between the end portion EG and the light-shielding member SH. The end portion PTE is located between the end portion PLE and the inspection pad TPD.

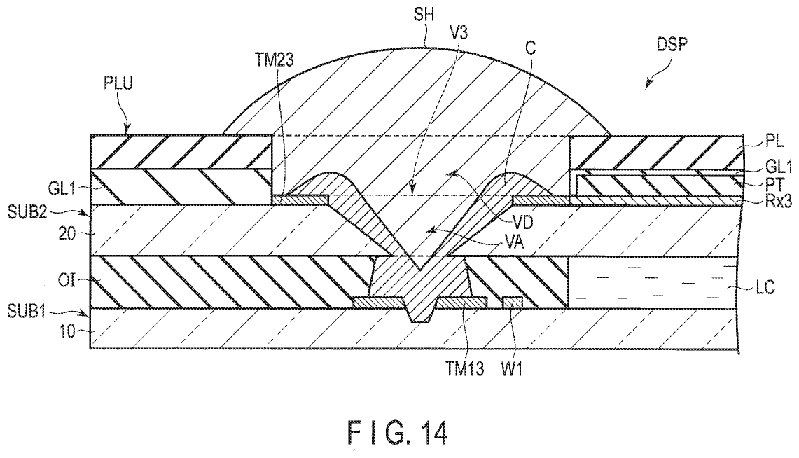

FIG. 14 is a cross section of another example of the display device DSP according to this embodiment. The structure shown in FIG. 14 is different from that of FIG. 2 in that the polarizer PL has a hole (second hole) VD.

The hole VD penetrates the polarizer PL and in the example illustrated, it penetrates the adhesive GL1 as well. The hole VD is formed to communicate to the hole VA. The light-shielding member SH is provided in the hole VD to fill, and also to be located in the connection hole V3 as well. Moreover, the light-shielding member SH is in contact with an upper surface PLU of the polarizer PL.

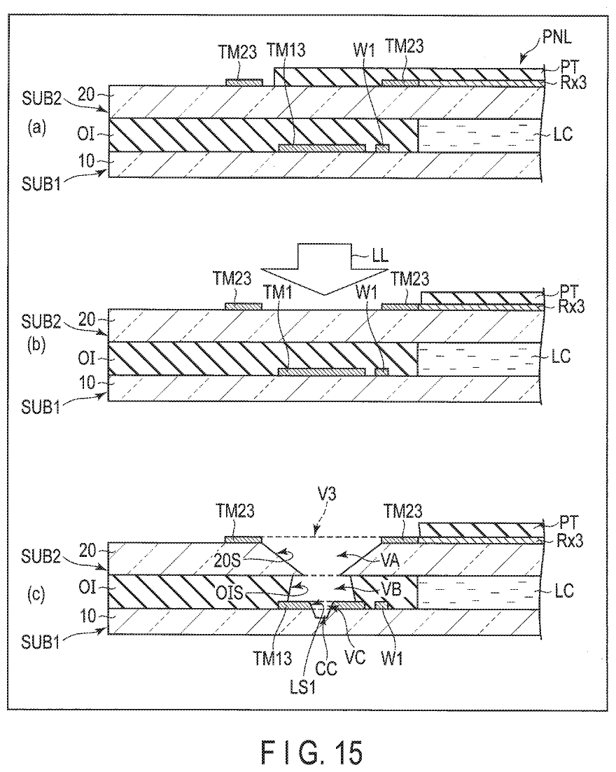

Next, an example of a method of manufacturing the above-explained display device DSP will be explained with reference to FIGS. 15 to 19.

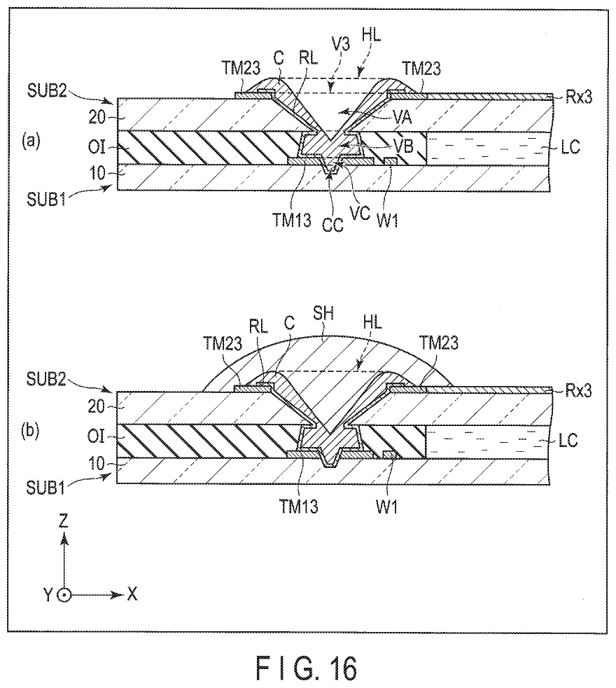

FIGS. 15 and 16 are each a cross-sectional view illustrating a process of manufacturing the display device DSP shown in FIG. 6.

First, as shown in FIG. 15, part (a), a display PNL is prepared. The display panel PNL illustrated here comprises a first substrate SUB1 at least including the first basement 10 and the first terminal TM13, and a second substrate SUB2 at least including the second basement 20 and the second terminal TM23. In the display panel PNL, the second basement 20 opposes the first terminal TM13, and while the second basement 20 being spaced from the first terminal TM13, the organic insulating film OI is located between the first basement 10 and the second basement 20.

Next, as shown in FIG. 15, part (b), laser beam LL is irradiated onto the protective member PT to remove the portion of the protective member PT, which is located within the second terminal TM23. Thereafter, the laser beam LL is irradiated onto the second substrate SUB2 to form the connection hole. As the laser beam source, for example, a carbon dioxide laser device or the like is applicable, but as long as it can drill a glass material or an organic material, any type, an excimer laser device is also applicable.

FIG. 15, part (c) shows the display panel PNL after irradiated with the laser beam LL. As the laser beam LL is irradiated onto the second substrate SUB2, the hole VA which penetrates the second basement 20 and the second terminal TM23 is formed. In the example illustrated, the hole VB, the hole VC and the concavity CC are also formed simultaneously. Thus, the connection hole V3 is formed for connecting the first terminal TM13 and the second terminal TM23 to each other. Moreover, due to the irradiation of the laser beam LL, the inner surface OIS is set back with respect to the inner surfaces 20S and LS1. That is, the diameter of the hole VB is greater than that of the hole VC, and the upper surface of the first terminal TM13 is exposed.

Next, as shown in FIG. 16, part (a), the relay layer RL is formed. Then, the connection member C is formed through the hole VA to electrically connect the first terminal TM13 and the second terminal TM23 to each other. More specifically, first, the display panel PNL is installed in a chamber and then the air in the chamber is exhausted. Then, the connection member C is injected to the hole VA in a vacuum (under an environment of a pressure lower than atmospheric pressure). Here, in some cases, the connection member C does not reach the holes VB and VC and the concavity CC to allow a vacuum state to remain in the connection hole V3. Here, gas such as air or inert gas is introduced to the chamber to reduce the degree of vacuum. Thus, due to the difference in atmospheric pressure between the vacuum and the surroundings of the display panel PNL, the connection member C flows from the hole VA into the holes VB and VC and the concavity CC. Thus, the connection member C is brought into contact with the first terminal TM13. Then, by removing the solvent contained in the connection member C, the volume of the connection member C is decreased, thus forming the hollow section HL.

The method of forming the connection member C explained above is a mere example and is not limited thereto. For example, a similar connection member C can be formed by such a procedure of injecting the connection member C into the hole VA under atmospheric pressure, and then removing the solvent contained in the connection member C. Moreover, for example, the relay layer RL can be formed by a method substantially similar to that of the connection member C.

Then, as shown in FIG. 16, part (b), the light-shielding member SH is formed. In the example illustrated, the light-shielding member SH is provided into the hollow section HL of the connection member C to fill. Moreover, the light-shielding member SH covers the connection member C and the second terminal TM23. The light-shielding member SH is formed using, for example, an epoxy resin and is hardened by heat. Applicable examples of the method of preparing the light-shielding member SH are photo lithography, screen printing, offset printing, application with a dispenser, and gravure printing. Note that the height of the light-shielding member SH along the third direction Z may be adjusted by, for example, such a technique of cutting the light-shielding member SH.

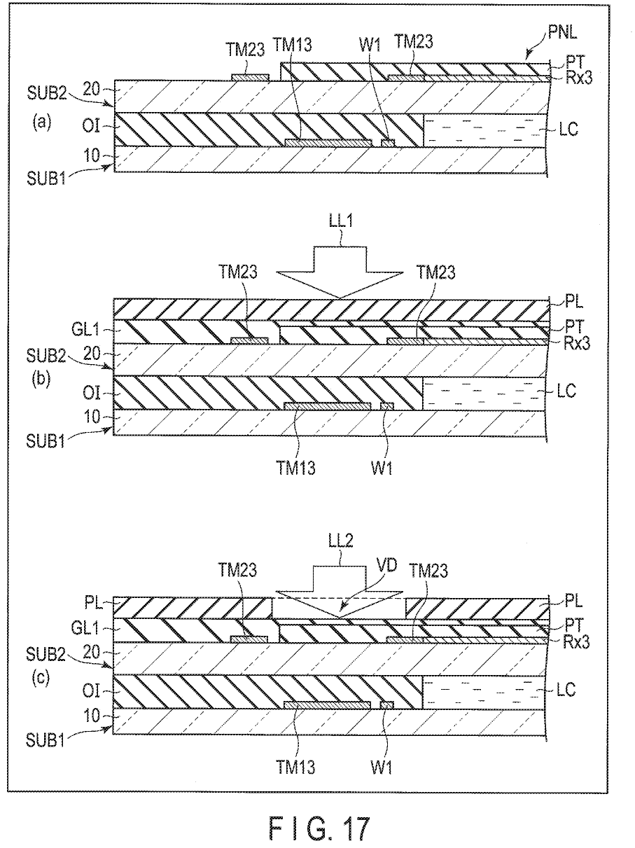

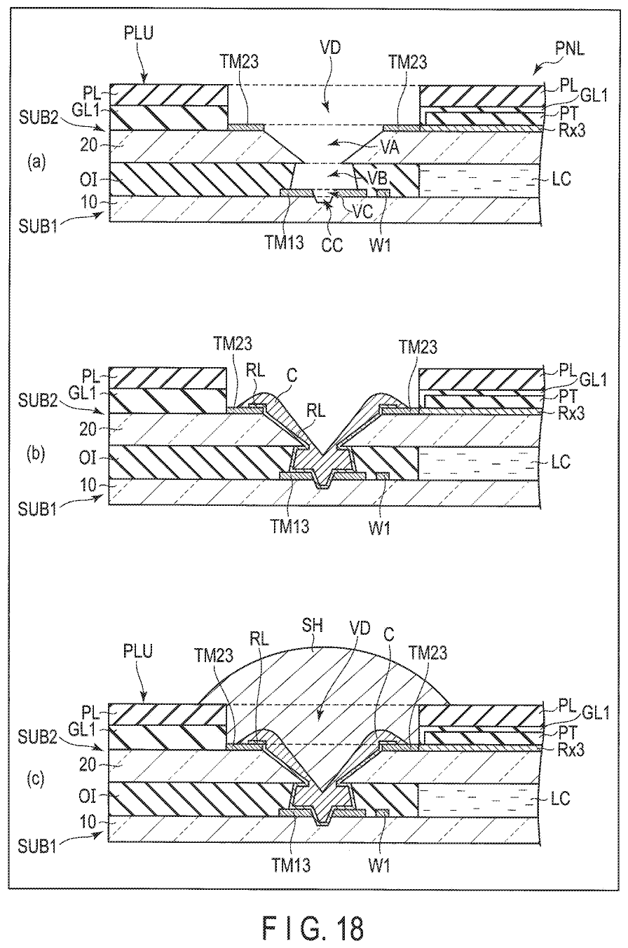

FIGS. 17 and 18 are diagrams showing processes of manufacturing the display device DSP shown in FIG. 14.

First, as shown in FIG. 17, part (a), a display PNL is prepared. The display panel PNL shown in FIG. 17, part (a) is equivalent to that shown in FIG. 15, part (a).

Next, as shown in FIG. 17, part (b), a polarizer PL is adhered onto the second substrate SUB2 by an adhesive GL1. Then, laser light L is applied irradiated onto the polarizer PL.

As shown in FIG. 17, part (c), with the laser beam LL1 irradiated onto the polarizer PL, the hole VD is formed in the polarizer PL to penetrate therethrough. Next, laser beam LL2 is irradiated onto the adhesive GL1 and the protective member PT to remove the portions of the adhesives GL1 and the protective member PT, which are located within the second terminal TM23. Then, laser beam LL2 is irradiated onto the second substrate SUB2 to form a connection hole therein.

FIG. 18, part (a), shows the display panel PNL after irradiated with the laser beam LL2. By irradiating the laser beam LL2, the hole VA, the hole VB, the hole VC and the concavity CC are formed in the position which overlaps the hole VD.

Next, as shown in FIG. 18, part (b), the relay layer RL and the connection member C are formed. The relay layer RL and the connection member C are formed by a similar method to that shown in FIG. 16, part (a).

Next, as shown in FIG. 18, part (c), the light-shielding member SH is formed. The light-shielding member SH is formed by a similar method to that shown in FIG. 16, part (b). Here, the light-shielding member SH is formed in the hole VD as well. Moreover, the light-shielding member SH is formed so as to be brought into contact with the upper surface PLU of the polarizer PL.

As shown in FIGS. 17 and 18, before forming the hole VA, the polarizer PL in the state where the hole VD is not formed may be adhered onto the second substrate SUB2.

FIG. 2 is a diagram of another process of manufacturing the display device DSP shown in FIG. 14.

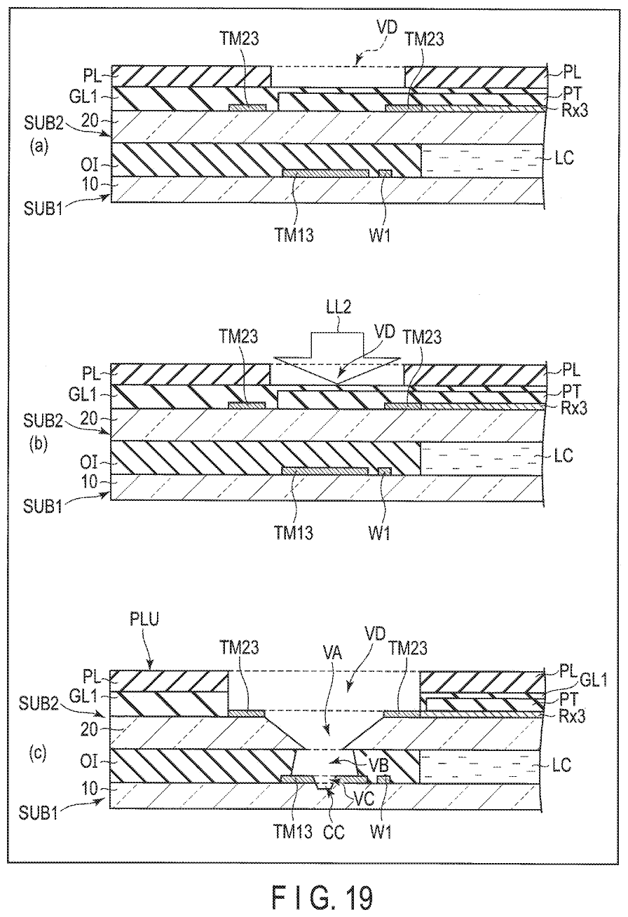

First, as shown in FIG. 19, part (a), a display panel PNL is prepared, and a polarizer PL with the hole VD is adhered onto the second substrate SUB2 by an adhesive GL1. Here, the display panel PNL thus prepared is equivalent to that shown in FIG. 15, part (a).

Next, as shown in FIG. 19, part (b), laser beam LL2 is irradiated onto the adhesive GL1 and the protective member PT to remove the portions of the adhesive GL1 and the protective member PT, which are located within the second terminal TM23. Then, the laser beam LL2 is irradiated onto the second substrate SUB2 to form the connection hole.

FIG. 19, part (c) shows the display panel PNL after irradiated with the laser beam LL2. By irradiating the laser beam LL2, the hole VA, the hole VB, the hole VC and the concavity CC are formed in the position which overlaps the hole VD. Then, as in the cases shown in FIG. 18, part (b) and part (c), the relay layer RL, the connection member C, and the light-shielding member SH are formed.

As shown in FIG. 19, before forming the hole VA, the polarizer PL with the hole VD formed therein may be adhered onto the second substrate SUB2.

Note that as shown in FIGS. 17 to 19, by forming the hole VA after adhering the polarizer PL onto the second substrate SUB2, residual attached on the upper surface of the polarizer PL while forming the hole VA can be removed together with the sheet attached on the upper surface of the polarizer PL. Moreover, the polarizer PL can be used in place of the protective film against laser beams.

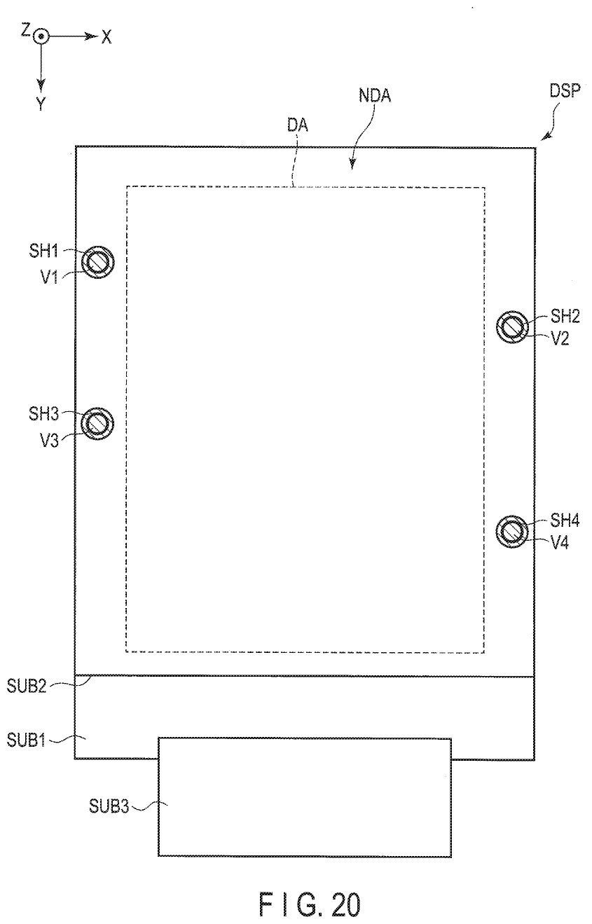

FIG. 20 is a plan view showing locations of the holes V1 to V4 and light-shielding members SH1 to SH4 relative to each other. Here, light-shielding members SH disposed to overlap the holes V1 to V4, respectively, are referred to as the light-shielding members SH1 to SH4.

In the example shown in FIG. 20, the light-shielding members SH1 to SH4 are conductive. Therefore, the light-shielding member SH1 and the light-shielding member SH3 are spaced from each other on one end side of the non-display area NDA. Moreover, the light-shielding member SH2 and the light-shielding member SH4 are spaced from each other on the other end side of the non-display area NDA.

In the example shown in FIG. 20 as well, advantageous effects similar to those of the above-described embodiment can be obtained.

FIG. 20 is a plan view showing locations of the holes V1 to V4 and light-shielding members SHa and SHb relative to each other.

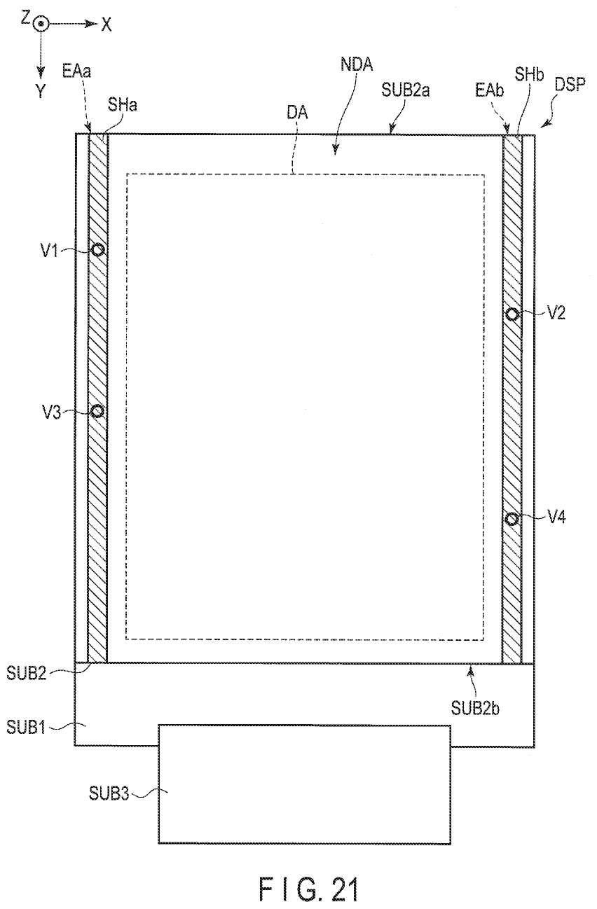

In the example shown in FIG. 21, the light-shielding members SHa and SHb are conductive. The light-shielding member SHa extends along the second direction Y on one end side of the non-display area NDA, and overlaps the holes V1 and V3. Moreover, the light-shielding member SHb extends along the second direction Y on the other end side of the non-display area NDA, and overlaps the holes V2 and V4. Thus, the light-shielding member SHa and SHb are non-conductive, and therefore one light-shielding member can be disposed continuously over two or more holes.

The second substrate SUB2 includes an end portion SUB2a extending along the first direction X. In the example illustrated, the light-shielding member SHa and SHb are continuously formed from the end portion SUB2a to the end portion SUB2b, but they may break to be apart between the end portion SUB2a and the end portion SUB2b.

In the example shown in FIG. 21 as well, advantageous effects similar to those of the above-described embodiment can be obtained.

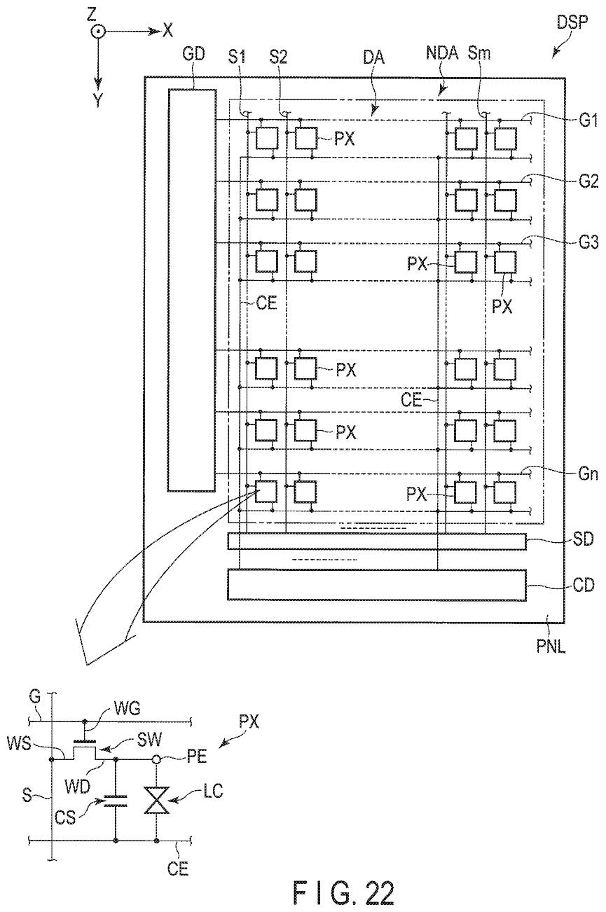

FIG. 22 is a diagram showing a basic configuration and an equivalent circuit of the display panel PNL shown in FIG. 1.

The display panel PNL includes a plurality of pixels PX in the display area DA. Here, the pixel is defined as a minimum unit which is individually controllable according to a pixel signal, and is provided, for example, in an area which includes a switching element provided in a position in which a scanning line and a signal line, which will be described later, cross each other. The pixels PX are arranged in a matrix in the first direction X and the second direction Y. Moreover, the display panel PNL comprises a plurality of scanning lines G (G1 to Gn), a plurality of signal lines S (S1 to Sm), a common electrode CE, etc., in the display area DA. The scanning lines G each extend along the first direction X so as to be arranged along the second direction Y. The signal lines S each extend along the second direction Y so as to be arranged along the first direction X. The scanning lines G and the signal lines S may not necessarily extend linearly, but part of the lines may be bent. The common electrode CE is disposed over the pixels PX. The scanning line the signal line S, and the common electrode CE are drawn to the non-display area NDA. In the non-display area NDA, the scanning lines G are connected to the scanning line drive circuit GD, the signal lines S are connected to the signal line drive circuit SD, and the common electrode CE is connected to the common electrode drive circuit CD. The signal line drive circuit SD, the scanning line drive circuit GD, and the common electrode drive circuit CD may be formed on the first substrate SUB1, and some or all of them may be built in the IC chip I1 shown in FIG. 1.

Each pixel PX comprises a switching element SW, a pixel electrode PE, the common electrode CE, a liquid crystal layer LC and the like. The switching element SW is constituted by a thin-film transistor (TFT), for example, and is electrically connected to the respective scanning line G and the respective signal line S. More specifically, the switching element SW comprises a gate electrode WG, a source electrode WS, and a drain electrode WD. The gate electrode WG is electrically connected to the scanning line G. In the example illustrated, an electrode electrically connected to a signal line S is referred to as a source electrode WS, whereas an electrode electrically connected to a pixel electrode PE is referred to as a drain electrode WD.

A scanning line G is connected to the switching elements SW of the respective pixels PX arranged along the first direction X. A signal line S is connected to the switching elements SW of the respective pixels PX arranged along the second direction Y. Each pixel electrode PE opposes the common electrode CE and drives the liquid crystal layer LC by an electric field produced between the pixel electrode PE and the common electrode CE. A storage capacitance CS is formed between, for example, the common electrode CE and the pixel electrode PE.

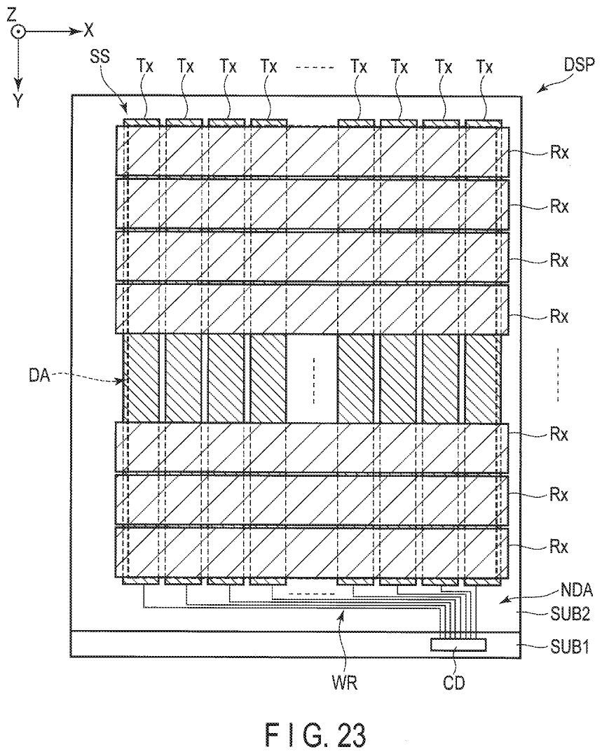

FIG. 23 is a plan view showing a configuration example of the sensor SS.

In the configuration example illustrated, the sensor SS comprises a sensor drive electrode Tx and a detection electrode Rx. In the example illustrated, the sensor drive electrodes Tx correspond to portions represented by downward sloping hatch lines and are provided on the first substrate SUB1. Further, the detection electrodes Rx correspond to an area indicated by upward sloping hatch lines, and are provided on the second substrate SUB2. The sensor drive electrodes Tx and the detection electrodes Rx intersect each other in the X-Y plane. The detection electrodes Rx oppose the sensor drive electrodes Tx along the third direction Z.

The sensor drive electrodes Tx and the detection electrodes Rx are located in the display area DA and some of them extend out to the non-display area NDA. In the example illustrated, the sensor drive electrodes Tx are each strip-shaped and elongated along the second direction Y, and are arranged along the first direction X at intervals. The detection electrodes Rx each extend along the first direction X and are arranged along the second direction Y at intervals. As described with reference to FIG. 1, the detection electrodes Rx are connected to the first terminals TM1 provided in the first substrate SUB1 and are electrically connected to the detection circuit RC via wiring lines. Each of the sensor drive electrodes Tx is electrically connected to the common electrode drive circuit CD via wiring lines WR. Note that the number, size, and shape of the sensor drive electrodes Tx and the detection electrodes Rx are not particularly limited, but can be changed variously.

The sensor drive electrodes Tx each includes the common electrode CE described above and has a function of generating an electric field between the respective pixel electrode PE and itself, and also a function of detecting the location of an object to be detected by generating a capacitance between the respective detection electrode Rx and itself.

The common electrode drive circuit CD supplies common drive signals to the sensor drive electrodes Tx each including the common electrode CE at display driving to display images on the display area DA. At sensing driving to carry out sensing, the common electrode drive circuit CD supplies sensor drive signals to the sensor drive electrodes Tx. Along with supplying of the sensor drive signals to the sensor drive electrodes Tx, the detection electrodes Rx output sensor signals required for sensing (that is, signals based on the change in the inter-electrode capacitance between the sensor drive electrodes Tx and the detection electrodes Rx). The sensor signals output from the detection electrodes Rx are input to the detection circuit RC shown in FIG. 1.

The sensor SS in each of the above-described configuration examples is not limited to a mutual capacitance type, which detects an object to be detected based on the change in electrostatic capacitance between a pair of electrodes (which is the electrostatic capacitance between the sensor drive electrode Tx and the detection electrode Rx in the above-described example), but may be of a self-capacitance type, which detects an object to be detected based on the change in the electrostatic capacitance of the detection electrodes Rx.

Moreover, in the example illustrated, the sensor drive electrodes Tx each extend along the second direction Y and are arranged along the first direction X at intervals therebetween, but the sensor drive electrodes Tx may be formed to extend along the first direction X, and arranged along the second direction Y at intervals. Here, the detection electrodes Rx each extend along the second direction Y and are arranged along the first direction X at intervals.

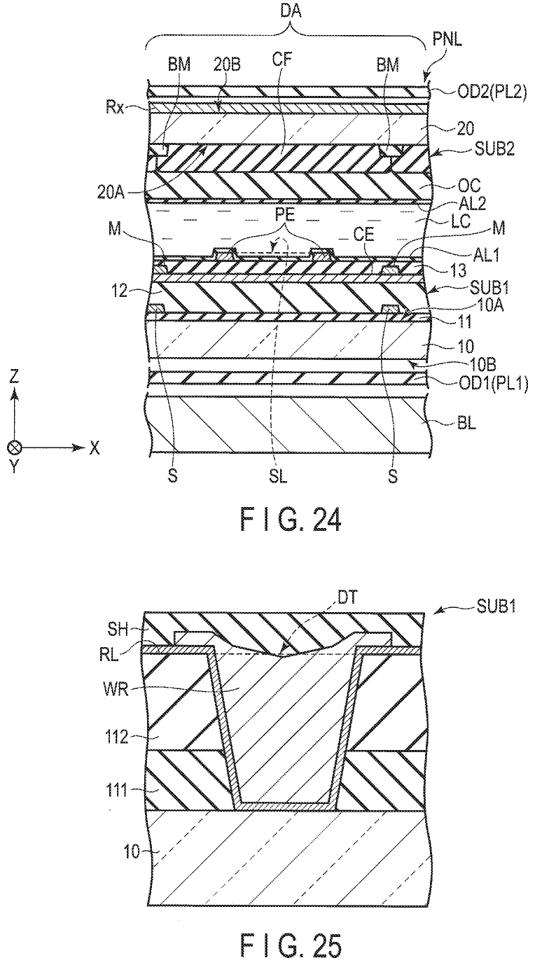

FIG. 24 is a cross section of a configuration of the display area DA of the display panel PNL shown in FIG. 1. The figure illustrates a cross-section of the display device DSP taken along the first direction X.

The display device DSP illustrated has a structure conforming to a display mode mainly using a lateral electric field which is substantially parallel to a main surface of the substrate. Note that the display panel PNL may have a structure corresponding to the display mode using a vertical electric field vertical to the main surface of the substrate, an electric field of a direction inclined to the main surface, or a combination of these fields. In the display mode using a lateral electric field, for example, such a structure is applicable that both of the pixel electrodes PE and the common electrodes CE are provided on either one of the first substrate SUB1 and the second substrate SUB2. In the display mode using a vertical electric field or an inclined electric field, for example, such a structure is applicable that either the pixel electrodes PE or the common electrodes CE are provided on the first substrate SUB1, and the other ones of the pixel electrodes PE and the common electrodes CE are provided on the second substrate SUB2. Note that the main surface of the substrate is a surface parallel to the X-Y plane.

The first substrate SUB1 comprises a first basement 10, signal lines S, a common electrodes CE, metal layers M, a pixel electrode PE, a first insulating film 11, a second insulating film 12, a third insulating film 13, a first alignment film AL1 and the like. Note that the switching elements, scanning lines, and various insulating films interposed therebetween and the like are not illustrated in the drawing.

The first insulating layer 11 is located on a main surface 10A of the first basement 10. The scanning lines and the semiconductor layer of the switching element (not shown) are located between the first basement 10 and the first insulating film 11. The signal lines S are located on the first insulating film 11. The second insulating film 12 is located on the signal lines S and the first insulating film 11. The common electrode CE is located on the second insulating film 12. The metal layers M is in contact with the common electrode directly above the respective signal lines S. In the example illustrated, the metal layers M are located on the common electrode CE, but may be located between the common electrode CE and the second insulating film 12. The third insulating film 13 is located on the common electrode CE and the metal layers M. The pixel electrode PE is located on the third insulating film 13. The pixel electrode PE opposes the common electrode CE via the third insulating film 13. Further, the pixel electrode PE comprises a slit SL at a position opposing the common electrode CE. The first alignment film AL1 covers the pixel electrode PE and the third insulation film 13.

Note that the configuration of the first substrate SUB1 is not limited that of the example illustrated, but the pixel electrode PE may be located between the second insulating film 12 and the third insulating film 13, and the common electrode CE may be located between the third insulating film 13 and the first alignment film AL1. In such a case, the pixel electrode PE is formed into a flat plate shape without a slit, whereas the common electrode CE is formed to comprise a slit opposing the pixel electrode PE. Further, the pixel electrode PE and the common electrode CE may be both formed in a comb-like shape, and arranged so as to engage with each other.

The second substrate SUB2 comprises a second basement 20, light-shielding layers BM, color filters CF, an overcoat layer OC, a second alignment film AL2, and the like.

The light-shielding layers BM and the color filters CF are located on a main surface 20A of the second basement 20. The light-shielding layers BM partition into the pixels and are located directly above the respective signal lines S. The color filters CF oppose the pixel electrode PE and partially overlap the respective light-shielding layers BM. The color filters CF include red color filters, green color filters, blue color filters, and the like. The overcoat layer OC covers the color filters CF. The second alignment film AL2 covers the overcoat layer OC.

Note that the color filters CF may be disposed in the first substrate SUB1. The color filters CF may include color filters of four or more colors. In the pixels which display white, a white color filter may be disposed, or a colorless resin material may be disposed, or an overcoat layer OC may be disposed without placing a color filter.

A detection electrode Rx is located on the main surface 20B of the second basement 20. The detection electrode Rx may be formed from a conductive layer containing a metal, or a transparent conductive material such as ITO or IZO, or from a multilayer structure in which a transparent conductive layer is stacked on a conductive layer containing a metal, or may be formed of a conductive organic material, a dispersing element of a fine conductive substance, or the like.

An optical element OD1 including a polarizer PL1 is located between the first basement 10 and the illumination device BL. An optical element OD2 including a polarizer PL2 is located on the detection electrode Rx. Each of the optical element OD1 and the optical element OD2 may include a retardation film as needed. Note that the polarizer PL2 is equivalent to the polarizer PL1 shown in FIGS. 2 and 14.

The scanning lines, the signal lines S, and the metal layers M may be formed of a metal material such as molybdenum, tungsten, titanium or aluminum, and they may be of a single- or a multi-layered structure. The common electrode CE and the pixel electrode PE are formed of a transparent and electrically conductive material such as ITO or IZO. The first insulating film 11 and the third insulating film 13 are inorganic insulating layers while the second insulating film 12 is an organic insulating film.

FIG. 25 is a cross section of an example of the display device DSP according to this embodiment. FIG. 25 shows an example case where the structure of the connection member C of the above-described embodiment is applied to the wiring lines W.

In the example illustrated, the first substrate SUB1 comprises a first basement 10, an inorganic insulating film 111, an organic insulating film 112, a relay layer RL, a wiring line W and a light-shielding member SH.

The inorganic insulating film 111 is disposed on the first basement 10. The insulating film 112 is disposed on the insulating film 111. The first substrate SUB1 comprises a trench DT which penetrates the inorganic insulating film 111 and the organic insulating film 112. The relay layer RL is provided on an inner surface of the trench DT. The wiring line W is formed in the trench DT to fill. The wiring line W is formed using, for example, the same material as that of the connection member C shown in FIG. 2.

The light-shielding member SH covers the wiring line W and the relay layer RL. Thus, it is possible to inhibit reflection from the wiring line W and the relay layer RL from being visually recognized. Further, with the light-shielding member SH, oxidization of the wiring line W can be suppressed.

The relay layer RL is located between the wiring line W, and each of the inorganic insulating film 111 and the organic insulating film 112. Thus, the adhesion between the wiring line W and the inorganic insulating film 111 and the adhesion between the wiring line W and the organic insulating film 112 can be maintained at the same time. Moreover, it was confirmed that, with the relay layer RL, the wiring line W is not detached in the thermal cycle test between −40° C. to 80° C. Therefore, it is possible to suppress cracking of the wiring line W, which causes the increase in the resistance of the wiring line W.

As described above, according to the embodiments, and a display device with a narrow frame and its manufacturing method at reduced costs can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

An example of the display device obtained from the structures discussed in the specification will be appended to below.

(1) A display device comprising:

a first substrate comprising a first basement and a first terminal;

a second substrate comprising a second basement opposing the first terminal and spaced from the first terminal, and a second terminal, the second substrate comprising a first hole penetrating the second basement;

a connection member formed through the first hole, which electrically connects the first terminal and the second terminal to each other; and

a light-shielding member which covers the connection member.

(2) The device according to item (1), wherein the light-shielding member is conductive.

(3) The device according to item (1), wherein the light-shielding member is non-conductive.

(4) The device according to item (3), wherein the light-shielding member contains one of carbon, titanium oxide, iron oxide, and a complex oxide of copper and chromium.

(5) The device according to item (2), wherein the light-shielding member contains at least one material of graphene, carbon nanotube, carbon nanobud, carbon black and glassy carbon.

(6) The device according to item (1), further comprising:

a polarizer opposing the second substrate,

wherein

the polarizer comprises a second hole communicating to the first hole, and

the light-shielding member is located in the second hole.

(7) The device according to item (1), further comprising:

a relay layer located between the connection member and the second basement,

wherein the relay layer contains a transition metal.

(8) The device according to item (7), further comprising:

an organic insulating film located between the first basement and the second basement and comprising a third hole penetrating the organic insulating film to communicate to the first hole,

wherein

the connection member passes the third hole, and

the relay layer is located between the connection member and the organic insulating film in the third hole.

(9) The device according to item (7), wherein

the transition metal is at least one of Ti, Zr, Hf and Ta.

(10) A display device comprising:

a first substrate comprising a first basement and a first terminal;

a second substrate comprising a second basement opposing the first terminal and spaced from the first terminal, a second terminal, the second substrate comprising a first hole which penetrates the second basement; and

a connection member provided through the first hole to electrically connect the first terminal and the second terminal to each other;

the connection member being provided in the first hole to fill and having a light-shielding property.

(11) The device according to item (10), wherein

the connection member contains at least one material of graphene, carbon nanotube, carbon nanobud, carbon black and glassy carbon.

(12) The device according to item (10), further comprising:

a relay layer located between the connection member and the second basement, wherein the relay layer contains a transition metal.

(13) The device according to item (12), further comprising:

an organic insulating film located between the first basement and the second basement, the organic insulating film comprising a third hole penetrating therethrough to communicate to the first hole,

wherein

the connection member passes through the third hole, and

the relay layer is located between the connection member and the organic insulating film in the third hole.

(14) The device according to item (12), wherein

the transition metal is at least one of Ti, Zr, Hf and Ta.

(15) A method of manufacturing a display device comprising a first substrate comprising

a first basement and a first terminal, and a second substrate comprising a second basement opposing the first terminal and spaced from the first terminal, and a second terminal, the method comprising:

forming a first hole which penetrates the second basement by irradiating a first laser beam onto the second substrate;

forming a connection member in the first hole which electrically connects the first terminal and the second terminal to each other; and

forming a light-shielding member which covers the connection member.

(16) The method according to item (15), further comprising:

adhering a polarizer onto the second substrate before forming the first hole;

forming a second hole which penetrates the polarizer, by irradiating a second laser beam onto the polarizer; and

forming the first hole in a position which overlaps the second hole by irradiating the first laser beam.

(17) The method according to item (15), further comprising:

forming the first hole in a position which overlaps the second hole by irradiating the first laser beam after adhering the polarizer comprising the second hole, onto the second substrate.

What is claimed is:

1. A display device comprising:
a first substrate comprising a first basement and a first terminal;
a second substrate comprising a second basement opposing the first terminal and spaced from the first terminal, and a second terminal, the second substrate comprising a first hole penetrating the second basement;
a connection member formed through the first hole, which electrically connects the first terminal and the second terminal to each other; and
a light-shielding member which covers the connection member.

2. The device according to claim 1, wherein
the light-shielding member is conductive.

3. The device according to claim 1, wherein
the light-shielding member is non-conductive.

4. The device according to claim 3, wherein
the light-shielding member contains one of carbon, titanium oxide, iron oxide and complex oxide of copper and chromium.

5. The device according to claim 2, wherein
the light-shielding member contains at least one material of graphene, carbon nanotube, carbon nanobud, carbon black and glassy carbon.

6. The device according to claim 1, further comprising:
a polarizer opposing the second substrate,
wherein
the polarizer comprises a second hole communicating to the first hole, and
the light-shielding member is located in the second hole.

7. The device according to claim 1, further comprising:
a relay layer located between the connection member and the second basement,
wherein
the relay layer contains a transition metal.

8. The device according to claim 7, further comprising:
an organic insulating film located between the first basement and the second basement and comprising a third hole penetrating the organic insulating film to communicate to the first hole,
wherein
the connection member passes the third hole, and
the relay layer is located between the connection member and the organic insulating film in the third hole.

9. The device according to claim 7, wherein
the transition metal is at least one of Ti, Zr, Hf and Ta.

10. A display device comprising:
a first substrate comprising a first basement and a first terminal;
a second substrate comprising a second basement opposing the first terminal and spaced from the first terminal, a second terminal, the second substrate comprising a first hole which penetrates the second basement; and
a connection member provided through the first hole to electrically connect the first terminal and the second terminal to each other;
the connection member being provided in the first hole to fill and having a light-shielding property.

11. The device according to claim 10, wherein
the connection member contains at least one material of graphene, carbon nanotube, carbon nanobud, carbon black and glassy carbon.

12. The device according to claim 10, further comprising:
a relay layer located between the connection member and the second basement,
wherein the relay layer contains a transition metal.

13. The device according to claim 12, further comprising:
an organic insulating film located between the first basement and the second basement, the organic insulating film comprising a third hole penetrating therethrough to communicate to the first hole,
wherein
the connection member passes through the third hole, and
the relay layer is located between the connection member and the organic insulating film in the third hole.

14. The device according to claim 12, wherein
the transition metal is at least one of Ti, Zr, Hf and Ta.

15. A method of manufacturing a display device comprising a first substrate comprising a first basement and a first terminal, and a second substrate comprising a second basement opposing the first terminal and spaced from the first terminal, and a second terminal, the method comprising:
forming a first hole which penetrates the second basement by irradiating a first laser beam onto the second substrate;
forming a connection member in the first hole which electrically connects the first terminal and the second terminal to each other; and
forming a light-shielding member which covers the connection member.

16. The method according to claim 15, further comprising:
adhering a polarizer onto the second substrate before forming the first hole;
forming a second hole which penetrates the polarizer, by irradiating a second laser beam onto the polarizer; and
forming the first hole in a position which overlaps the second hole by irradiating the first laser beam.

17. The method according to claim 15, further comprising:
forming the first hole in a position which overlaps the second hole by irradiating the first laser beam after adhering the polarizer comprising the second hole, onto the second substrate.
